(19) United States
(12) Patent Application Publication
(10) Pub. No.: US 2002/0163179 A1
(43) Pub. Date: Nov. 7, 2002

(54) Transparent tamper-indicating data sheet

(76) Inventors: Andrew D. Dubner, St. Paul, MN (US); Brian W. Dunne, New South Wales (AU); James M. Jonza, Woodbury, MN (US); Lynn E. Lorimor, Minneapolis, MN (US); Graeme Mann, New South Wales (AU); Shivshankar Venkataramani, Eagan, MN (US)

Correspondence Address: Office of Intellectual Property Counsel, 3M Innovative Properties Company, PO Box 33427, St. Paul, MN, 55133-3427, US

(21) Appl. No.: 09/846,632

(22) Filed: May 1, 2001

(51) Int. Cl. B42D 15/00

(52) U.S. Cl. 283/72

(57) ABSTRACT

A transparent data sheet is provided wherein a transparent durable film (a first major component), such as polyester or a multilayer optical film (MOF), is adhered to a fragile layer (a second major component), such as a holographic foil or a security laminate, such as Confirm™ Security Laminate, either the fragile sheet or film or the durable film being printed with identification and/or verification information. The components of the transparent data sheet are laminated together with or without an adhesive layer between the two major components, such that the printed information or image is sandwiched between the two films. The two major components have the same outside dimensions and are congruent.

### FIELD OF THE INVENTION

This invention pertains to a transparent data page using at least a single layer of a fragile material and a layer of durable film, or at least a two layers of two different fragile materials, such that either combination of the two layers form a durable sheet.

### BACKGROUND OF THE INVENTION

Documents of value such as passports, identification cards, entry passes, ownership certificates, financial instruments, and the like, are often assigned to a particular person by personalization data. Personalization data, often present as printed images, can include photographs, signatures, fingerprints, personal alphanumeric information, and barcodes, and allows human or electronic verification that the person presenting the document for inspection is the person to whom the document is assigned. There is widespread concern that forgery techniques can be used to alter the personalization data on such a document, thus allowing non-authorized people to pass the inspection step and use the document in a fraudulent manner.

A number of security features have been developed to authenticate the document of value, thus preventing forgers from producing a document, which resembles the authentic document during casual observation, but lacks the overt or covert security features known to be present in the authentic document. Overt security features include holograms and other diffractive optically variable images, embossed images, and color-shifting films, while covert security features include images only visible under certain conditions such as inspection under light of a certain wavelength, polarized light, or retroreflected light. Even more sophisticated systems require specialized electronic equipment to inspect the document and verify its authenticity. Often, these security features are directed at verifying the authenticity of the parent document, but convey little information regarding the authenticity of the personalization data. Further features that convey information about, or prevent, tampering with the personalization data are needed.

Tamper-proof features that have been included in documents of value include encapsulation of the printed images between laminated layers, laminates which will show evidence of tampering, and cover layers which can't be removed without destroying the integrity of the layer which covers the printed image. Still, sophisticated forgers have found techniques to expose and alter the printed images that form the personalilzation data, especially where the reverse side of such data is hidden by an opaque layer. There would be great utility in a document which includes tamper-proof, tamper-evident, and security features. Particularly, such a document which allows easy inspection of both the front and reverse sides of the personalization data image would add a new level of security to prevent forgeries.

### SUMMARY OF INVENTION

Briefly, in one aspect of the present invention, a transparent data sheet is provided wherein a transparent durable film (a first major component), such as polyester or a multilayer optical film (MOF), is adhered to a fragile layer (a second major component), such as a holographic foil or a security laminate, such as Confirm™ Security Laminate, either the fragile sheet or film or the durable film being printed with identification and/or verification information. The components of the transparent data sheet are laminated together with or without an adhesive layer between the two major components, such that the printed information or image is sandwiched between the two films. The two major components have the same outside dimensions and are congruent.

The term “fragile” as used in this application means a film or material that is mechanically weak and is typically constructed with a removable carrier layer for ease of handling or stability for printing. As used in the application “durable” means a film that is a free-standing film, without the necessity of a carrier layer and is thermally stable to withstand laminating or other processing temperatures, typically in the range of 100 to 150° C., as well as repeated handling, such as typical passport use. Furthermore, both the durable layer and the fragile layer can be constructed to have more that a single component or layer. Additionally, the durable layer could comprise a series of durable and fragile layers. For example, a durable layer could be configured to include a multilayer optical film, an adhesive layer and a second multilayer optical film or a multilayer optical film and a layer of polyester film. Similarly, a fragile layer could be comprised of a holographic foil, a high refractive index layer and a protective coating. These configurations are merely for illustration and should not be construed to limit the present invention.

According to one embodiment of the invention a transparent data sheet is comprised of a multilayer optical film adhered to a fragile layer. Such multilayer optical films may also provide additional security features, such as clear to cyan multilayer optical film described in U.S. Pat. No. 6,045,894.

In another embodiment of the invention, a transparent data sheet is comprised of a first fragile layer adhered to a second fragile layer, wherein the laminate of the two fragile sheets is a durable sheet. Advantageously, such a construction could produce a transparent data sheet comprised of a holographic foil (a first fragile sheet) and a layer of glass beads embedded in a layer of beadbond, such as Confirm™ Security Laminate (a second fragile sheet).

In any of the above embodiments, an optional thin layer of hot-melt adhesive can be used on either the durable or fragile sheet. For example, a hot melt adhesive can be coated onto a holographic foil, the adhesive of which can be printed with any necessary identification indicia, such as names, photographs and the like. Once printed, the holographic foil can be laminated at or above the melt temperature of the hot melt adhesive.

Alternatively, the two layers can be laminated together when one of the layers has a hot meltable surface, such as a multilayered film, wherein one of the surface layers is a low melting point thermoplastic.

Advantageously, the present invention provides a transparent data sheet that contains one or more security features, including but not limited to the destruction of the fragile layer indicating tampering or attempted delamination. Overt security features can include holograms and other diffractive optically variable images, embossed images, and color-shifting films, while covert security features include images only visible under certain conditions such as inspection under light of a certain wavelength, polarized light, or retroreflected light.

In yet another embodiment, a process of manufacturing a transparent data sheet is provided, comprising the steps of (1) printing identification information onto a surface of a first layer and (2) laminating this first layer, printed side to the inside to another film or layer, wherein both layers are optically transparent and one layer is more fragile than the other.

In still another embodiment, a process for manufacturing a transparent data sheet is provided, comprising the steps of (1) providing a printable surface of a first fragile layer, (2) providing a second layer, which is a durable layer or is a fragile layer, with the proviso that combination of the first and second layer provide a durable sheet, and (3) providing instructions for printing and assembling the transparent data sheet.

### BRIEF DESCRIPTION OF THE DRAWINGS

FIG. 1 is an end view of an embodiment of the present invention.

FIG. 2 is an end view of an alternative embodiment of the present invention.

FIG. 3 is an end view of an alternative embodiment of the present invention.

### DESCRIPTION OF THE PREFERRED EMBODIMENT(S)

### General Construction

A transparent data sheet is provided wherein a transparent durable film (a first major component) is adhered to a fragile layer (a second major component), such as a holographic foil or a security laminate, such as Confirm™ Security Laminate, such that the fragile layer is printed with identification and/or verification information. The components of the transparent data sheet are laminated together with or without an adhesive layer between the two major layers.

In an alternative embodiment, a transparent data sheet is provided wherein the first major component is a second fragile layer, wherein the combination of the first and second major components form a durable transparent sheet.

This construction may also include a tie layer for bonding the layers of the sheet together, a patterned coating layer with differential adhesion for providing an indication of tampering by delamination, and additional indicia visible under various lighting conditions.

Furthermore, both the durable layer and the fragile layer can be construed to have more that a single component or layer. For example, a durable layer could be configured to include a multilayer optical film, an adhesive layer and a second multilayer optical film or a multilayer optical film and a layer of polyester film. Similarly, a fragile layer could be comprised of a holographic foil, a high refractive index layer and a protective coating. These configurations are merely for illustration and should not be construed to limit the present invention.

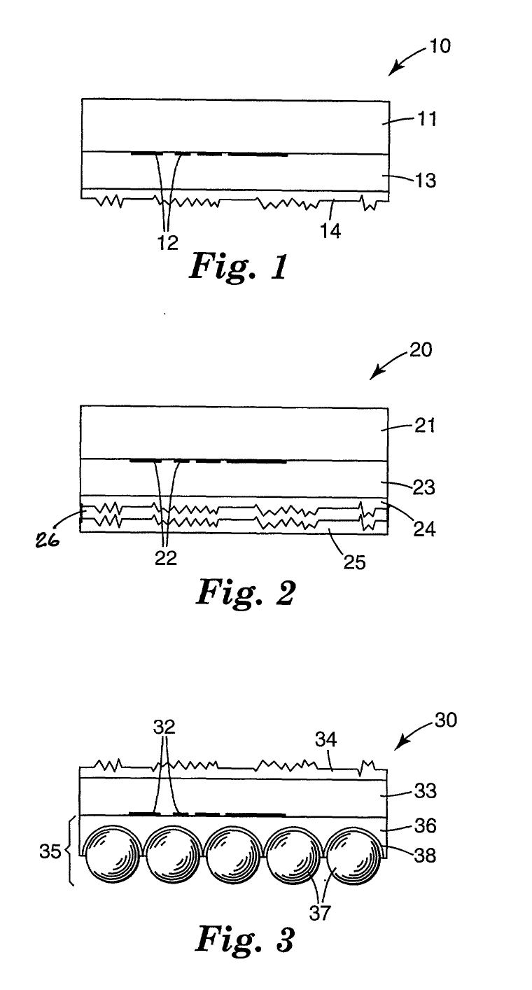

Referring now to FIG. 1, a transparent data sheet 10 according to the present invention is illustrated comprising a durable film 11, printed indicia 12, an adhesive layer 13 and a holographic foil 14. Generally, durable film 11 includes multilayer optical film, polyester, biaxially oriented polypropylene and any other film that is a free-standing film, without the necessity of a carrier layer and is thermally stable to withstand laminating or other processing temperatures, typically in the range of 100 to 150° C., as well as repeated handling, such as typical passport use. Furthermore, durable layer 11 can be constructed with a combination of films, for example, a multilayer optical film with a polyester film. Holographic foil 14 represents the fragile layer of the present invention. Although illustrated as a holographic foil, layer 14 also includes foil without a holographic structure, multilayer polyurethane films, glass beads in a beadbond layer, such as Confirm™ Security Laminate or any film or material that is mechanically weak and is typically constructed with a removable carrier layer for ease of handling or stability for printing.

Referring now to FIG. 2, an alternative embodiment of the present invention is shown. A transparent sheet 20 is illustrated comprising a durable film 21, printed indicia 22, an adhesive layer 23, a holographic foil 24, and a high refractive index coating 26. As stated above in reference to FIG. 1, the durable film 21, and the holographic foil 24 can also be a combination of other films and/or coatings, for example a protective coating 25.

Referring now to FIG. 3, yet another alternative embodiment of the present invention is illustrated. A transparent sheet 30 is illustrated comprising a fragile film (identified as a holographic foil) 34, an adhesive layer 33, printed indicia 32 and a second fragile layer 35 comprised of glass beads 37, a reflective coating 38 and a beadbond layer 36. Additional security elements can be added to the second fragile layer 35 by adding printing on a predetermined array of glass beads 37, prior to the reflective coating 38.

### Fragile Materials or Layers

The term “fragile” as used in this application means a film or material that is mechanically weak and is typically constructed with a removable carrier layer for ease of handling or stability for printing.

Such fragile films include but are not limited to holographic foils of typical thickness from 1 to 5 microns, glass beads in a beadbond layer of typical thickness from 100 to 175 microns, optical stacks of typical thickness from 0.25 to 25 microns and multilayered polyurethane films of typical thickness from 10 to 50 microns.

### Holographic Hot Stamping Foil

A holographic layer typically comprises two parts: a structured layer and an optional reflective layer. The structured layer can be formed by several methods that are well known in the art, as disclosed in U.S. Pat. No. 4,856,857 (Takeuchi et al.), the contents of which is incorporated by reference herein. It may be made of materials such as polymethyl methacrylate, nitrocellulose, and polystyrene. The structured layer includes a microstructured relief pattern of holographic or diffractive optically variable images in the form of logos or patterns that reflect or interfere with light. An embossed microstructured layer may be formed by contacting the material from which the structured layer will be made with a non-deformable embossing plate having a microstructured relief pattern, and applying heat and pressure to impart the microstructure. Alternatively, the structured layer may be made by any other suitable process, such as radiation curing, and may be made of materials such as urethane, epoxy, polyester, and acrylate monomers and oligomers, which are formulated with photoinitiators, cast on a non-deformable tool having a microstructured relief pattern, and radiation cured to form the microstructure in the material.

The optional reflective layer is coated on the structured layer either before or after embossing. The reflective layer has a refractive index differing from, and preferably higher than the structured layer. In a preferred embodiment, the reflective layer is substantially transparent and colorless. Illustrative examples of suitable reflective layer materials include but are not limited to bismuth trioxide, zinc sulfide, titanium dioxide, and zirconium oxide, which are described in U.S. Pat. No. 4,856,857 (Takeuchi et al.). Less transparent materials such as thin aluminum or silver, or patterned reflectors can also be used. The reflective layer enhances the reflection of light through the structured layer due to the difference in refractive index between the structured and reflective layers. Thus, the structured holographic pattern is more readily visible to the unaided eye once the reflective layer is coated on the structured layer, and an adhesive can be directly applied to the structured layer without diminishing the visibility of the structured pattern.

Retroreflective layers may comprise one or more types of retroreflective materials, including microsphere-type retroreflective materials and cube cornertype retroreflective materials. Confirm™ is a preferred retroreflective layer, as disclosed in U.S. Pat. No. 3,801,183 (Sevelin et al.) and herein incorporated by reference, comprises an exposed monolayer of glass microspheres, indicia patterns printed on the back surface of the microspheres, a reflector layer on the back surface of the printed indicia and the glass microspheres, and a beadbond layer. The reflector layer is preferably transparent, high refractive index material. The authenticity of Confirm™ security laminate can be verified by the presence of a retroreflective effect.

An alternate retroreflective layer, as disclosed in U.S. Pat. No. 2,407,680 (Palmquist et al.), may comprise an enclosed monolayer of glass microspheres, which are coated in a spacing resin comprising, for example, polyvinyl butyral or polyester. The spacing resin conforms to the microspheres. A reflector layer underlies spacing resin, and may comprise opaque materials such as silver, aluminum, chromium, nickel, or magnesium, or transparent high-index reflector materials such as those described above for use on the holographic structured layer, such as zinc sulfide, or multilayer reflectors as described in U.S. Pat. No. 3,700,305 (Bingham). Thus, light that enters the retroreflective layer is focused by the glass microspheres through the spacing resin, and reflected by the reflector layer back through the spacing resin and glass microspheres to an observer.

### Imaging and Adhesive Layers

An image can be formed on the exposed face of a hot-melt adhesive layer by any of several techniques. Furthermore, a hot-melt adhesive layer can be on either of the major layers and therefore the printed indicia can be on either layer, prior to being sandwiched between the two major layers. Preferred techniques employ dry toner, liquid toner, or ink-jet printing. Another technique employs a thermal mass transfer or thermal dye transfer donor element that may contain a pigment or dye and is positioned face-to-face with the hot-melt adhesive layer, whereupon a thermal print head can selectively apply heat from the back of the donor element to transfer color and binder to the hot-melt adhesive. This process can be repeated using additional colors to provide a three-color or four-color transfer image. For a discussion of a comparable thermal imaging process, see U.S. Pat. No. 3,898,086 (Franer et al.).

Preferred hot melt adhesives are matched to the imaging technique to accept the imaging without subsequent blurring after lamination to the second layer. Furthermore, the hot melt adhesives useful in the present invention should form strong enough bonds between the two layers that attempted delamination of the two layers would destroy the fragile layer and effectively destroy the adhesive layer. As used in this application “effectively destroy” means that the adhesive layer can not be re-used without evidence of tampering. Preferably, these hot melt adhesives are coated as a matte or textured layer, such that the micro-structured surface of these layers aids in the reduction of trapped air, during any lamination process.

For inkjet printing, the hot-melt adhesive layer should include an ink-jet receptive layer. Such adhesives and ink-receptive layers are described in U.S. Ser. No. 09/591,592, filed Jun. 9, 2000, entitled “Inkjet Printable Media.”

For use with dry toner and thermal mass transfer imaging techniques, a preferred class of hot-melt adhesives that forms strong bonds is linear, random copolyesters of one or more aromatic dibasic acids and one or more aliphatic diols, modified with up to about 30 mole % of one or more aliphatic dibasic acids, as in U.S. Pat. No. 4,713,365 (Harrison). Among other useful classes of hot-melt adhesives are ethylene/vinyl acetate (EVA) copolymers, ethylene/acrylic acid (EAA) copolymers, ethylene/ethyl acrylate (EEA) copolyrners, ethylene/methyl acrylate (EMA) copolymers, and polyethylene.

For a thermal dye transfer donor system, the Tg of useful hot-melt adhesives should be from about −15° to about 150° C. At substantially lower Tg, there would be a danger of image blurring or image migration. At a Tg substantially higher than said preferred range, it would be necessary to employ undesirably high temperatures to laminate. Preferably, the Tg of the hot-melt adhesive is from about 40° C. to about 100° C.

The layer of hot-melt adhesive preferably is between about 25 to 50 μm (microns) in thickness when the document to which the overlay is to be applied is porous like paper. A thickness of about 25 μm would be adequate when the document is smooth, e.g., a plastic film or plastic-coated paper. Even when the document is smooth, the thickness of the hot-melt adhesive preferably is at least about 50 μm when one of the layers is a retroreflective layer of glass beads with a beadbond layer, and dye or pigment is used to form the image on the hot-melt adhesive layer. Substantially thinner layers might result in migration of the imaging dye from the hot-melt adhesive layer into the beadbond layer of the retroreflective sheeting. On the other hand, a thickness of the hot-melt adhesive exceeding about 200 μm facilitates tampering of the layers by peeling apart within the adhesive layer. Furthermore, it can be difficult to form uniform coatings of the hot-melt adhesive at substantially greater thicknesses.

### Durable Films

As used in the application “durable” means a film that is free-standing film, without the necessity of a carrier layer and is thermally stable to withstand laminating or other processing temperatures, typically in the range of from 100 to 150° C., as well as repeated handling, such as typical passport use.

When the durable film is a thermoplastic film, it preferably is poly(ethylene terephthalate), as such films are typically scratch-resistant and have good transparency and good dimensional stability over a wide range of temperatures. Other useful simple thermoplastic films include polycarbonates, polyimides, cellulose acetate, polyethylene naphthalate, and polypropylenes, such biaxially oriented polypropylene.

A preferred method involves the steps of (a) pre-attaching the durable layer, into a document, such as a passport book, (b) printing on the exposed surface of the fragile material surface, a reverse image of information specific to the bearer, optionally including the bearer's portrait, and (c) laminating the durable layer with the fragile layer within the passport book, thereby forming a transparent data sheet. If, subsequently, someone were to be able to delaminate the data sheet, the fragile portion of the laminate would be destroyed.

### Multilayer Optical Film

A preferred component of the present invention is a multilayer film comprising alternating layers of at least a first polymer and a second polymer; the film appearing substantially clear at approximately a zero degree observation angle, and colored at at least one observation angle greater than a predetermined shift angle. This film is described in U.S. Pat. No. 6,045,894 (Jonza et al.), herein incorporated by reference. The color is preferably cyan. Stated in different terms, the invention includes a multilayer film comprising alternating layers of at least a first polymer and a second polymer, the film transmitting substantially all incident visible light at approximately a zero degree observation angle, and transmitting substantially all visible light except a selected portion of the red light at at least one observation angle greater than a predetermined shift angle. In another embodiment, the invention includes a multilayer film comprising alternating layers of at least a first polymer and a second polymer, the film appearing substantially clear at approximately a zero observation angle for light of either polarization state, and appearing colored for one polarization while appearing clear for the other polarization at at least one observation angle greater than a predetermined shift angle. Particular advantages of the invention are described in greater detail below.

In simplest terms, the multilayer film of the present invention appears to be clear when viewed by an observer at a zero degree observation angle, and to exhibit a visible color when viewed at an observation angle that is greater than a predetermined shift angle. As used herein, the term “clear” means substantially transparent and substantially colorless, and the term “shift angle” means the angle (measured relative to an optical axis extending perpendicular to the film) at which the film first appears colored.

For simplicity, the multilayered film will be described largely in terms of a color shift from clear to cyan. This effect is produced by creating a multilayer film that includes multiple polymeric layers selected to enable the film to reflect light in the near infrared (IR) portion of the visible spectrum at zero degree observation angles, and to reflect red light at angles greater than the shift angle. Depending on the amount and range of red light that is reflected, the film appears under certain conditions to exhibit a visible color, commonly cyan. An observer viewing the inventive film at approximately a zero degree observation angle sees through the film, whereas an observer viewing the film at an observation angle greater than the shift angle sees a cyan-colored film.

The advantages, characteristics and manufacturing of multilayer optical films are most completely described in U.S. Pat. No. 5,882,774, which is incorporated herein by reference. The multilayer optical film is useful, for example, as highly efficient mirrors and/or polarizers, as well as providing a clear to cyan film that can be effectively used as a security element. A particularly unique characteristic of the multilayer optical film is that at least one of the materials used to fabricate the multilayer optical film has the property of stress induced birefringence, such that the index of refraction of the material is affected by the stretching process, common in film manufacture.

### Additional Layers

For example, a holographic layer and the high refractive index layer could be bonded together by a tie layer. Alternatively, a hot melt adhesive layer and a durable film could be bonded together using a tie layer. Suitable materials for such a tie layer include primers or adhesives, as either a coating or a film, such as urethanes, olefins, vinyls, and acrylics. The tie layer may be any appropriate thickness, and may be applied either to the holographic layer or to the retroreflective layer, or both, prior to bonding those two layers together. Additionally, a scratch resistant layer may be used on the outer surface of either layer.

### Method of Manufacturing

A process of manufacturing a transparent data sheet is comprises the steps of (1) printing identification information onto a surface of a first layer and (2) laminating this first layer, printed side to the inside to another film or layer, wherein both layers are optically transparent and one layer is more fragile than the other. The printing or imaging process is as described above and can be accomplished with either the fragile layer or the durable layer.

Preferably, a hot lamination process is used to “bond” or laminate the two layers together. However, other methods of laminating two layers together can be used and are known to those skilled in the art of lamination.

In still another embodiment, a process for manufacturing a transparent data sheet is provided, comprising the steps of (1) providing a printable surface of a first fragile layer, (2) providing a second layer, which is a durable layer or is a fragile layer, with the proviso that combination of the first and second layer provide a durable sheet, and (3) providing instructions for printing and assembling the transparent data sheet.

In addition to using the transparent data sheet in passports, this data sheet can be used with other documents of value, such as identification cards or labels, entry passes, ownership certificates, financial instruments, and the like.

This invention is further illustrated by the following examples that are not intended to limit the scope of the invention. In the examples, all parts, ratios and percentages are by weight unless otherwise indicated. The following test methods were used to evaluate and characterize the printing ink with additives compositions produced in the examples. All materials are commercially available, for example from Aldrich Chemicals (Milwaukee, Wis.), unless otherwise indicated or described.

### EXAMPLES

### Example 1

A piece of transparent hologram foil, obtained from Crown Roll Leaf, Paterson, N.J., was attached to a sheet of paper carrier with a piece of pressure sensitive transfer adhesive. The 1 mil polyester liner side of the hologram foil was in contact with the pressure sensitive adhesive, and the foil and adhesive were slightly larger than a typical passport page, about 4″×5.5″. The paper carrier was A4 size.

The exposed side of the hologram foil contained an adhesive sizing applied during the usual production of holographic hot stamping foil. The exposed adhesive sizing was imaged with a passport data page image containing variable data, a machine-readable zone, and a personalized photo of the passport bearer. The imaging was performed using a Konica KP1040 color toner laser printer, and the image was in reverse. The paper with imaged hologram foil was removed from the printer and placed in a passport book.

The passport book had a piece of multilayer optical film with a color shift from clear to cyan sewn into the spine of the book. The 40 μm clear to cyan film had first been deeply embossed with lines or symbols, such as the seal of a country. Then 25 μm of a hot melt adhesive of ethylene acrylic acid copolymer was extruded and bonded to the clear to cyan film using UV light and heat, forming a heat activated laminate film.

The imaged side of the hologram foil on paper carrier was put in contact with the hot melt adhesive side of the clear to cyan film in the book. The book was closed and passed through a desktop hot laminator, (commercially available from TLC, Chicago, Ill.) at approximately 121° C. at the adhesive interface. The paper carrier and attached polyester liner from the hologram foil were peeled from the hologram foil, which was now adhered to the clear to cyan film. The result was a transparent data page with transparent hologram foil on one side, through which the passport data could be read, and the clear to cyan laminate on the other side, which verified that the data page was authentic when tilted at an angle to view the cyan color.

### Example 2

A piece of transparent hologram foil, obtained from Kurz Transfer Products in Charlotte, N.C., was attached to a paper premask carrier that was coated with pressure sensitive adhesive. The polyester liner side of the hologram foil was in contact with the pressure sensitive adhesive on the premask. The entire foil and premask was slightly larger than a typical passport page, about 4″×7.5″.

The exposed side of the hologram foil contained an adhesive sizing applied during the usual production of holographic hot stamping foil. The exposed adhesive sizing was imaged with a passport data page image containing variable data, a machine-readable zone, and a personalized photo of the passport bearer. The imaging was performed using a Hewlett Packard HP4500 color toner laser printer, and the image was in reverse. The premask carrier with imaged hologram foil was removed from the printer and placed in a passport book.

The passport book had a piece of multilayer optical film with a color shift from clear to cyan (as described in Example 1) coated with a hot melt adhesive sewn into the spine of the book.

The imaged side of the hologram foil on premask carrier was put in contact with the hot melt adhesive side of the clear to cyan film in the book. The book was closed and passed through a desk top hot laminator, (commercially available from TLC, Chicago, Ill.) at approximately 121° C. at the adhesive interface. The premask carrier and attached polyester liner from the hologram foil were peeled from the hologram foil, which was now adhered to the clear to cyan film. The result was a transparent data page with transparent hologram foil on one side, through which the passport data could be read, and the clear to cyan film on the other side, which verified that the data page was authentic when tilted at an angle to view the cyan color.

### Example 3

A piece of Confirm™ Security Laminate (commercially available from 3M Co., St. Paul, Minn.), was attached to a piece of paper with a pressure sensitive adhesive. The paper bead carrier side of the Confirm™ Security Laminate was in contact with the pressure sensitive adhesive, the Confirm™ Security Laminate and adhesive being the size of a passport page, about 3.5×5″. The Confirm™ Security Laminate was imaged using an HP4500 color toner laser printer. The image contained variable data, a machine-readable zone, and a personalized photo of the passport bearer. The image was in reverse. The paper with the imaged Confirm™ Security Laminate was removed from the printer and placed in a passport book.

The passport book had a piece of multilayer optical film with a color shift from clear to cyan (as described in Example 1) sewn into the spine of the book. The imaged side of the Confirm™ Security Laminate on the premask carrier was put in contact with the hot melt adhesive side of the clear to cyan film in the book. The book was closed and passed through a desktop hot laminator, at approximately 121° C. at the adhesive interface. The paper and attached bead carrier were peeled from the Confirm™ Security Laminate, which was now adhered to the clear to cyan film. The result was a transparent data page with Confirm™ Security Laminate on one side, through which the passport data could be read, and the clear to cyan film on the other side, which verified that data page was authentic when tilted at an angle to view the cyan color.

### Example 4

A piece of transparent hologram foil, obtained from Kurz Transfer Products in Charlotte, N.C., was attached to a paper premask carrier which was coated with pressure sensitive adhesive as described in Example 2. The polyester liner side of the hologram foil was in contact with the pressure sensitive adhesive on the premask. The entire foil and premask was slightly larger than a typical passport page, about 4″×7.5″.

The exposed side of the hologram foil contained an adhesive sizing applied during the usual production of holographic hot stamping foil. The exposed adhesive sizing was imaged with a passport data page image containing variable data, a machine-readable zone, and a personalized photo of the passport bearer. The imaging was performed using a Hewlett Packard HP4500 color toner laser printer, and the image was in reverse. The premask carrier with imaged hologram foil was removed from the printer and placed in a passport book containing a sewn-in Confirm™ Security Laminate on a paper liner bead carrier. The imaged side of the hologram foil on the premask carrier was put in contact with the hot melt adhesive side of the Confirm™ Security Laminate in the book. The book was closed and passed through a desktop hot laminator, at approximately 250° F. at the adhesive interface.

The premask carrier and attached polyester liner from the hologram foil were peeled from the hologram foil, which was now adhered to the Confirm™ Security Laminate. Then the paper bead carrier on the Confirm™ Security Laminate was peeled off, resulting in a transparent data page with a transparent hologram foil on one side, through which the passport data could be read, and the Confirm™ Security Laminate on the other side, which verified that the data page was authentic when a Confirm™ Security Laminate retroreflective viewer was used. It is suggested that the sewn-in edge of Confirm™ Security Laminate be attached with a narrow piece of oriented polyester film with hot melt adhesive, such that the supported edge would be more robust, particularly at the sewn-in edge.

### Example 5

A piece of transparent hologram foil (Kurz Transfer Products, Charlotte, N.C.) was attached to a paper pre-mask (as described in previous examples). The exposed side of the hologram foil contained an adhesive sizing applied during the usual production of holographic hot stamping foil. The exposed adhesive side was imaged in reverse with variable data, machine readable zone, and a photograph using a HP 4500 color toner laser printer. The imaged foil was transferred directly to a polarizer multilayer optical film (commercially available from 3M Co, St. Paul, Minn.), previously sewn into the spine of a passport book, by a hot lamination process at 135° C. When the paper premask was peeled away, the imaged hologram foil was transferred intact to the polarizer multilayer optical film, which did not contain an adhesive layer. The article resulting from the above process was a transparent data page. The verification of the transparent data page was carried out as follows:

The holographic elements, the photograph and other relevant data appeared on the front side of the transparent page and the multilayer optical film underneath was essentially transparent, though with a grey mirror effect. The data page was then turned over along the spine of the passport to view the reverse side of the image and an additional polarizer film, such as a polarizer multilayer optical film (commercially available from 3M Co, St. Paul, Minn.) or a standard dichroic polarizer sheet was used as a verifying device. When the verifying polarizer was rotated until it crossed the polarizer with holographic images, the data on the transparent data page was substantially blocked out by the high reflectivity of the two crossed polarizer films, and the holographic images were visible. When the polarizer was rotated at 90 degrees to be parallel to the polarizer laminate, the data was again visible and the holographic images were only faintly visible. Thus, the authenticity of the passport could be verified by immigration and other governmental authorities.

Since the transparent data page contained a polarizer film , printed information on an adjacent passport page (for example, coat of arms etc.) was invisible when viewed through a verifying polarizer as described above through the front side of the data page. The authenticity of this page could also be verified using an electronic passport verification device such as Borderguard™ (available from Imaging Automation, Bedford, N.H.) with a polarized light source.

### Example 6

Latent Image Technology Ltd. (Israel) has developed a Latent Image Technology where the latent images are embedded in a variety of materials based on the radiation chemistry of polymers (U.S. Pat. No. 6,124,970). Utilizing this technology, LIT has the ability to create completely invisible, high-quality graphic images that remain completely invisible to the human eye, until viewed through a standard linear or circular polarizer. A sample label containing a latent image was obtained from LIT Ltd. and was applied to a passport page. This label could be a standard seal of a country etc. Polarizer multilayer optical film (commercially available from 3M Co, St. Paul, Minn.) was used as a transparent data page (previously sewn into the spine of the passport book) adjacent to the page containing the latent image. The multilayer optical film from Example 5, which is a polarizer, could be utilized to decode the latent image by bringing it in contact or close to the latent image label. Thus the transparent data page by itself, could be used as a verifier by passport control and other governmental authorities.

Various modifications and alterations of this invention will become apparent to those skilled in the art without departing from the scope and principles of this invention, and it should be understood that this invention is not to be unduly limited to the illustrative embodiments set forth hereinabove. All publications and patents are incorporated herein by reference to the same extent as if each individual publication or patent was specifically and individually indicated to be incorporated by reference.

What is claimed:

1. A transparent data sheet comprising:
(a) a transparent durable film,
(b) a transparent fragile layer, and
(c) at least one security element
wherein printed identification and/or verification information is sandwiched between the transparent durable film and the transparent fragile layer, and the two layers are laminated together.

2. A transparent data sheet comprising:
(a) a transparent fragile layer,
(b) a second transparent fragile layer, and
(c) at least one security element
wherein printed identification and/or verification information is sandwiched between the two transparent fragile layers, and the two layers are laminated together, with the proviso that the laminate is durable.

3. The transparent data sheet according to claims 1 or 2 wherein the transparent fragile layer is a holographic foil.

4. The transparent data sheet according to claims 1 or 2 wherein the transparent fragile layer is a retroreflective layer of glass beads in a beadbond layer.

5. The transparent data sheet according to claims 1 or 2 wherein the transparent fragile layer is a foil.

6. The transparent data sheet according to claims 1 or 2 wherein the transparent fragile layer is a optical stack.

7. The transparent data sheet according to claims 1 or 2 further including a high refractive index coating, coated on the outer surface of the transparent fragile layer.

8. The transparent data sheet according to claim 7 further including a protective coating, coated on the outer surface of the high refractive index coating.

9. The transparent data sheet according to claims 1 or 2 wherein the transparent fragile layer is a multilayered polyurethane film.

10. The transparent data sheet according to claim 1 wherein the durable film is a multilayer optical film.

11. The transparent data sheet according to claim 10 wherein the multilayer optical film is comprised of at least one material that exhibits stress induced birefringence.

12. The transparent data sheet according to claim 1 wherein the durable film is a polyester, polypropylene, polycarbonate, polyimide, or cellulose acetate.

13. The transparent data sheet according to claims 1 or 2, wherein the transparent fragile layer is comprised of more than one fragile material.

14. The transparent data sheet according to claim 1 wherein the durable film is comprised of one or more durable layers.

15. The transparent data sheet according to claim 2 wherein the second transparent fragile layer is a retroreflective layer of glass beads in a beadbond layer.

16. The transparent data sheet according to claim 1 wherein the transparent durable film is a multilayer optical film and the transparent fragile film is retroreflective layer of glass beads in a beadbond layer.

17. The transparent data sheet according to claim 2 wherein the the transparent fragile film is retroreflective layer of glass beads in a beadbond layer and the second transparent fragile film is a holographic foil.

18. The transparent data sheet according to claim 1 wherein the transparent durable film is a multilayer optical film and the transparent fragile film is a holographic foil.

19. The transparent data sheet according to claims 1 or 2 further including a layer of hot melt adhesive.

20. In combination:
(a) transparent data sheet according to claims 1 or 2, and
(b) a passport, wherein the transparent data sheet is inserted or otherwise attached to the passport.

21. In combination:
(a) transparent data sheet according to claims 1 or 2, and
(b) a document of value, wherein the transparent data sheet is inserted or otherwise attached to the document of value.

22. The combination according to claim 21 wherein the document of value is an indentification card.

23. A process for manufacturing a transparent data sheet comprising the steps of:
(1) providing a printable surface of a first fragile layer,
(2) providing a second layer, which is a durable layer or is a fragile layer, with the proviso that combination of the first and second layer provide a durable sheet, and
(3) providing instructions for printing and assembling the transparent data sheet, such that upon assembly, the two layers are laminated together.

24. A process of manufacturing a transparent data sheet comprising the steps of:
(1) printing identification information onto a surface of a first layer and
(2) laminating this first layer, printed side to the inside to another film or layer, wherein both layers are optically transparent and one layer is more fragile than the other.
